(19) United States
(12) Patent Application Publication
(10) Pub. No.: US 2017/0079242 A1
(43) Pub. Date: Mar. 23, 2017

(54) Pet Greet and Speak

(71) Applicant: Keith Andre Mosley, Atlanta, GA (US)

(72) Inventor: Keith Andre Mosley, Atlanta, GA (US)

(21) Appl. No.: 14/862,188

(22) Filed: Sep. 23, 2015

(51) Int. Cl. A01K 15/02; G06F 3/16

(52) U.S. Cl. CPC A01K 15/021; G06F 3/165; G06F 3/167

(57) ABSTRACT

The Pet Greet and Speak is a pet to human communication device that enables a pet to trigger a prerecorded greeting or announcement for their pet parents to hear. A greeting or announcement is pre-recorded on the Pet Greet and Speak. The recorded message is played whenever the pet comes in contact with the sensor surface provided.

This invention relates to a pet to human communication device, and more particular a device that enables a pet to trigger a prerecorded greeting or announcement for their pet parents.

### BACKGROUND OF THE INVENTION

Canine body language has been studied by researchers and scientists for years. Dogs are equipped with this very reliable and consistent language to help them communicate their intentions to one another. Their primary goal in using their language is to reduce and resolve conflict. Dogs use this very same language with humans as well, but we just don't know enough to actually understand it. I'm not talking about the overt signals which we all know, like a growl, bark or snap, but the full array of their language. When interacting with our dogs and other dogs, we can look out for the wagging tail, scratching at the door, turning in short circles, yelping, the lip lick, the ear flick, and the head turn; just to name a few. These are just some of the many cues dogs use to communicate with us each time we interact with them. They use this language to essentially tell us, “I'm happy to see you” or “I'm hungry” or “I need go outside”, just to name a few. Pet parents yern for new ways to strengthen the pet parent bond and communicate with their pets. They use photo apps that allow pets to do the talking through animated photos. Some use a videophone feeder which allows pet parents to interact with their pet from anywhere. The videophone feeder allows pet parents to see, hear, speak to, provide a comforting scent and give a pet a treat using a smart phone or computer. Dog owners have posted numerous videos of dogs making howling or barking sounds that resemble words on the internet.

The object of the present invention is to enable pets to communicate with their pet parents via a prerecorded message that is triggered when the pet comes into contact with a sensory area located on the surface of the invention. The means to record, play, erase, and adjust the volume are provided along with a low voltage loudspeaker. Once the pet parent records the message to be played the Pet Greet and Speak is ready for use. The messages can be short and sentimental, “I missed you while you were away.” Or it can be whimsical, “Who does a dog have to lick in order to get something to eat around here?” The pet parent can utilize “classic conditioning” methodology to train their pet to trigger the recording.

Although the invention is illustrated and described in relationship to specific embodiments, it is nevertheless not intended to be limited to the details shown, since various modifications and structural changes may be made therein without departing from the spirit of the invention and within the scope and range of equivalents of the claims.

The construction and operation of the invention, however, together with additional objects and advantage thereof will be best understood from the following description of specific embodiments when read in connection with the accompanying drawings.

### SUMMARY OF THE INVENTION

The Pet Greet and Speak includes a sensory area; a loudspeaker; DC battery compartment; AC receptacle; On/Off switch; the means to record, play, and erase messages; ability to adjust the volume and suction cups positioned on the underside. The device plays a prerecorded message when the pet comes into contact with the aforementioned sensory area located on the face of the invention.

### BRIEF DESCRIPTION OF THE DRAWINGS

FIG. 1 is a perspective view of the Pet Greet and Speak according to a first embodiment of the present invention shown with a sensor panel, a loudspeaker, suction cups, recessed microphone, button control panel and electrical cord which supplies AC (Alternating Current). The volume control can utilize a button, wheel, slide knob, or any other commonly used items to adjust volume.

FIG. 2 is a back view (Control Panel) of the Pet Greet and Speak according to a second embodiment of the present invention showing the power indicator light, “On/Off Switch”, recessed microphone”, “Record”, “Play”, “Erase”, “Volume” buttons and an AC Receptacle that allows an electrical adapter to be inserted for the purpose of supplying electricity to the device. The location of the aforementioned items is not restricted to the back panel. Two of the four suction cups are shown.

FIG. 3 is a top view of the Pet Greet and Speak according to a third embodiment of the present invention showing the speaker panel and sensor panel.

FIG. 4 is a left side view of the Pet Greet and Speak according to a fourth embodiment of the present invention showing two of four suction cups, the edges of the speaker panel, sensor panel, and control panel. The broken line outline of the battery case depicts the general location of the battery case inside the base.

FIG. 5 is a bottom view of the Pet Greet and Speak according to a fifth embodiment of the present invention showing the four suction cups, and DC/Battery case cover.

### DETAILED DESCRIPTION OF THE PREFERRED EMBODIMENTS

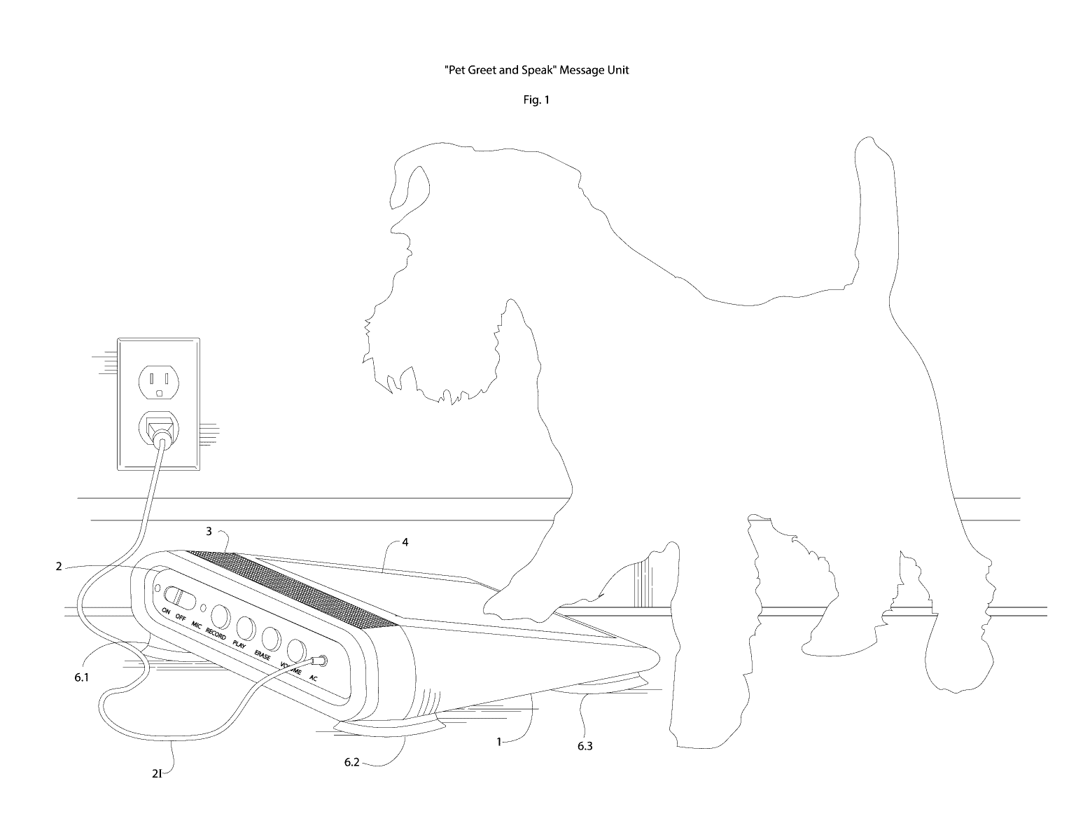

Referring to drawings in detail, wherein like numerals indicate like elements throughout, there is shown in FIGS. 1 through 5 preferred embodiments of a pet to human communication device, to be referred to as the Pet Greet and Speak 1 going forward, in accordance with the present invention. The geometrical shape of the present invention is for illustrative purposes. However, it is within the spirit and scope of the invention to make cosmetic changes to the appearance of the Pet Greet and Speak 1.

Referring to FIG. 1, in the perspective view of the Pet Greet and Speak 1 a control panel 2, loudspeaker 3, sensor panel 4, AC power cord 2i, and floor suction cups (6.1, 6.2, 6.3). Touching the sensor panel 8 will play the recorded message.

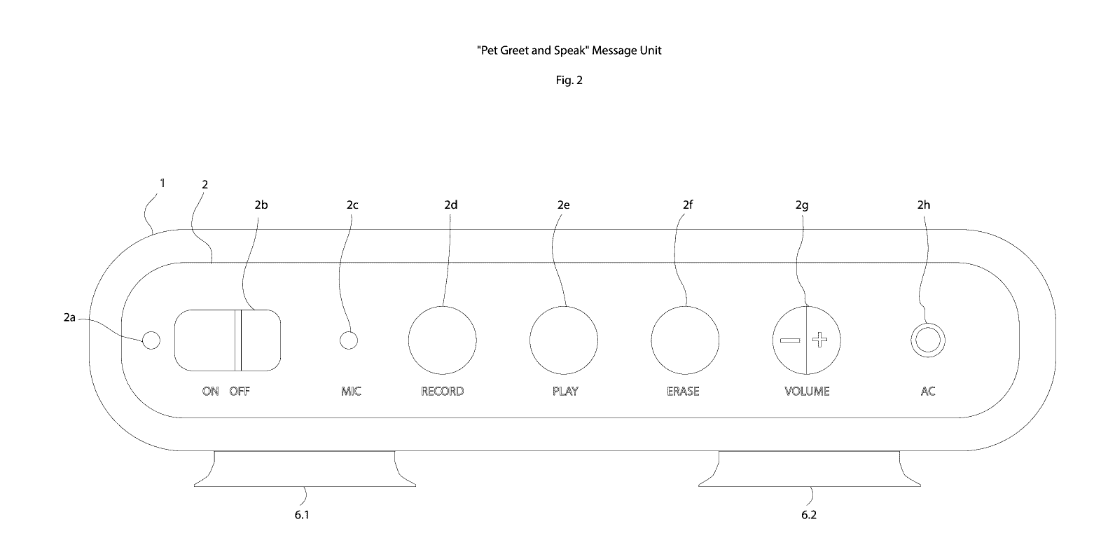

Referring to FIG. 2, a power indicator light 2a, On/Off switch 2b, microphone 2c, a record button 2d, play button 2e, erase button 2f, volume control button 2g, AC receptacle 2h, and two of the four suction cups (6.1, 6.2) are displayed. Record button 2d is engaged to record an announcement, Play button 2e is engaged to review the recorded announcement, Erase button 2f is used to delete an existing message. Volume button 2g is used to adjust the sound level of loudspeaker 3.

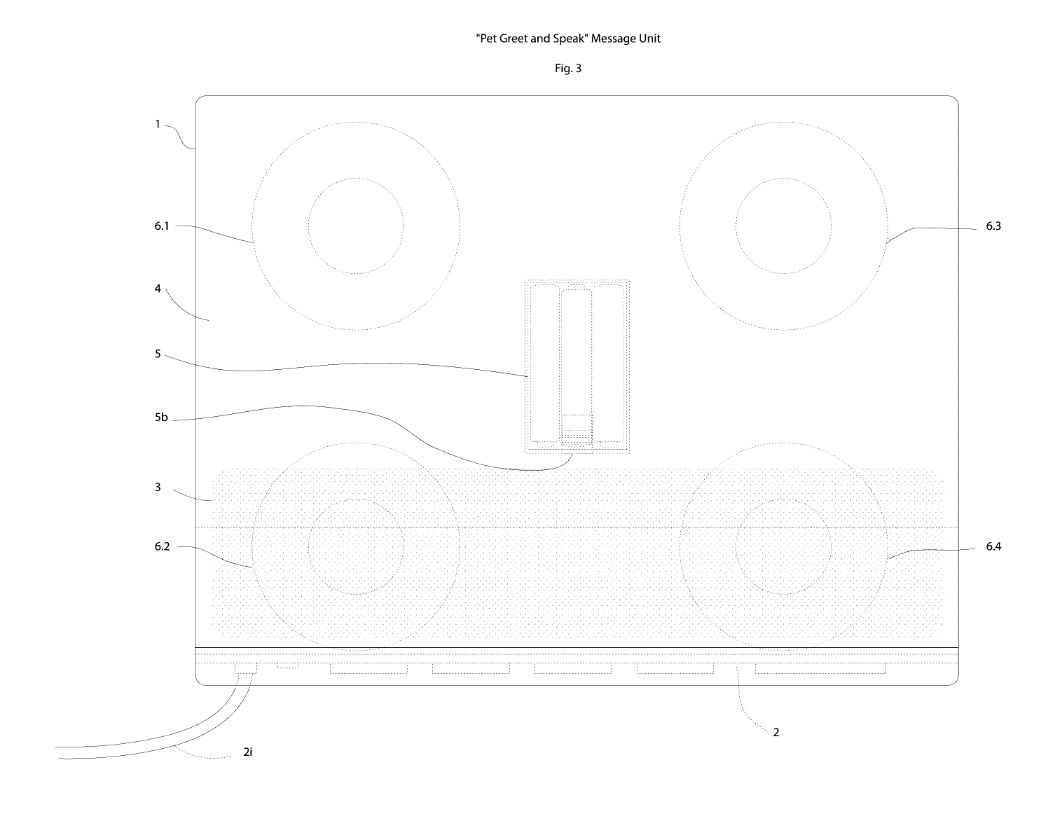

Referring to FIG. 3, is an aerial view of the Pet Greet and Speak 1. Loudspeaker 3 and sensor panel 4 are displayed. Prerecorded message is played when sensor panel is touched. The cutaway perspective exposes battery case 5 and cover 5b, four suction cups (6.1-6.4), control panel 2 and AC power cord 2i.

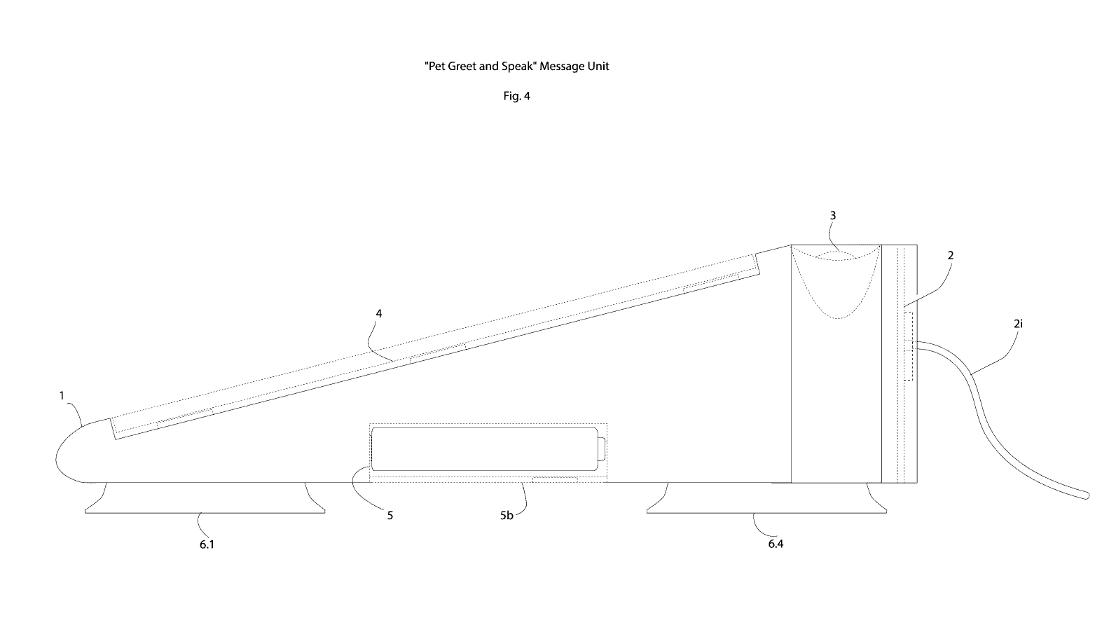

Referring to FIG. 4, is a side view of the Pet Greet and Speak 1. Edges of sensor panel 4, loudspeaker 3, control panel 2, AC power cord 2i and two of the four suction cups (6.1, 6.4) are shown. The cutaway exposes the battery case 5, battery case cover 5b and how batteries look when in place. Batteries are shown for illustrative purposes only and are not claimed as a part of the invention.

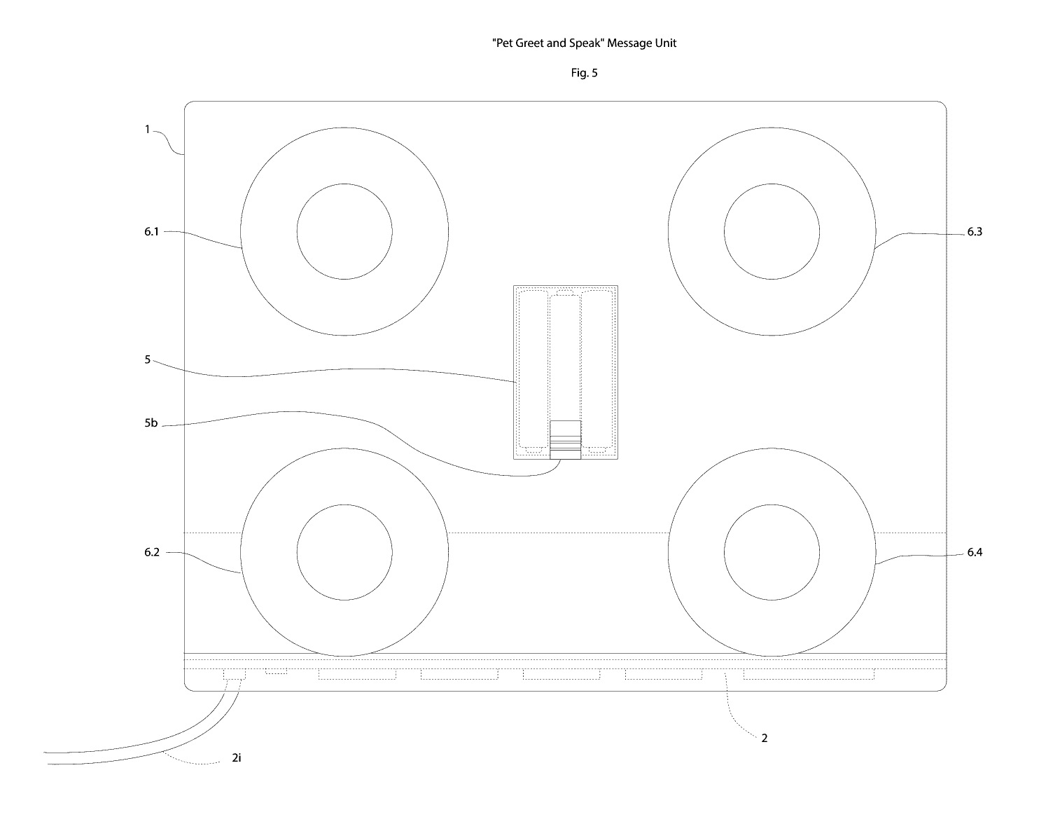

Referring to FIG. 5, is a bottom view of the Pet Greet and Speak 1. DC/battery compartment 5, and the battery case cover 5b are located on the bottom of the Pet Greet and Speak 1 along with suction cups 6.1, 6.2, 6.3 and 6.4. Cutaway view of battery case cover 5b exposes batteries, which are shown for illustrative purposes only.

What is claimed:

1. The Pet Greet and Speak device that provides the means for a pet to communicate with their pet parent via prerecorded messages, comprising:
(a) A sensory area that triggers a prerecorded greeting or announcement when touched by a pet.
(b) The means to record greetings and announcements that can be heard via the loudspeaker provided.
(c) The means to supply electrical power via the use of a battery or household electricity.
(d) Suction cups that enables the Pet Greet and Speak to remain stationary.
